(19) United States
(12) Patent Application Publication
(10) Pub. No.: US 2025/0309551 A1
(43) Pub. Date: Oct. 2, 2025

(54) RADIO TRANSMISSION SYSTEM

(71) Applicant: AGC Inc., Tokyo (JP)

(72) Inventor: Kumiko KAMBARA, Tokyo (JP)

(73) Assignee: AGC Inc., Tokyo (JP)

(21) Appl. No.: 19/235,003

(22) Filed: Jun. 11, 2025

Related U.S. Application Data
(63) Continuation of application No. PCT/JP2023/042143, filed on Nov. 24, 2023.

(30) Foreign Application Priority Data
Dec. 13, 2022 (JP) 2022-198617

(51) Int. Cl. H01Q 15/14; H01Q 1/24; H01Q 15/00

(52) U.S. Cl. CPC H01Q 15/14; H01Q 1/246; H01Q 15/0086

(57) ABSTRACT

A radio transmission system of which the radio-wave propagation environment is improved is provided. A radio transmission system comprises a base station configured to perform radio communication in a frequency band within a range of 1 GHz or higher and 300 GHz or lower; a first reflector configured to reflect a direct wave emitted from the base station; and a second reflector configured to reflect an electromagnetic wave reflected by the first reflector, wherein when a maximum gain of a transmitting antenna of the base station is 5 dBi or higher and 30 dBi or lower, a sum total of a first straight-line distance D1 from the base station to the first reflector and a second straight-line distance D2 from the first reflector to the second reflector is 2.5 m or longer and 250.0 m or shorter.

### INCORPORATION BY REFERENCE

This application is based upon and claims the benefit of priority from Japanese patent application No. 2022-198617, filed on Dec. 13, 2022, and PCT application No. PCT/JP2023/042143 filed on Nov. 24, 2023, the disclosure of which is incorporated herein in its entirety by reference.

### BACKGROUND

The present invention relates to a radio transmission system.

Radio base stations have been increasingly installed indoors and outdoors in order to automate manufacturing processes and office work, implement control and management by remote control and AI (Artificial Intelligence), and realize automated driving. Radio base stations have also been installed indoors such as factories, plants, offices, and commercial facilities, and outdoors such as highways and railway tracks, as well as other indoor or outdoor situations such as medical sites and event venues. In 5th generation mobile communication standards (hereinafter referred to as “5G”), frequency bands at 6 GHz or lower called “sub-6” and 28 GHz bands which are classified as millimeter-wave bands are provided. In the next-generation 6G mobile communications standards, it is expected that the frequency band will be extended to sub-terahertz bands. By using such high-frequency bands, the communication bandwidth is greatly extended, so that a large amount of data can be communicated with a small delay.

Since radio waves having a highly straight-traveling property are used in 5G, there may be places where such radio waves are less likely to reach. In particular, in places where NLOS (Non-Line-Of-Sight) spots from which the antenna of the base station cannot be directly seen are likely to occur, means for sending radio waves emitted from the base station to a desired area is required. A configuration in which electromagnetic reflecting apparatuses are arranged along at least a part of a production line has been proposed (see, e.g., International Patent Publication No. WO2021/199504). Further, an artificial reflection surface called a “meta-surface” has been developed in order to make the reflection direction and the beam width more flexible. The meta-surface is formed of periodic structures or patterns that are finer than the wavelength and designed so as to reflect radio waves in a desired direction (see, e.g., Diaz-Rubio et al., Sci. Adv. 2017:3:e1602714.). Since a meta-surface makes it possible to obtain a desired reflection angle while maintaining a planar arrangement/configuration, it can effectively function as a reflector even in an environment in which there is not enough space to install a large number of electromagnetic-wave reflecting panels.

### SUMMARY

Blind zones occur in various places depending on the environment in which the base station is located. By placing a reflector(s) at a proper position(s), it is possible to perform radio communication with the base station in an NLOS environment in which a direct wave emitted from the base station cannot be received. However, it is difficult to efficiently reduce blind zones and sufficiently improve the radio quality just by placing a reflector(s) that reflects the direct wave emitted from the base station. One of the objects of the present invention is to provide a radio transmission system of which the radio-wave propagation environment is improved.

In an embodiment, a radio transmission system comprises:
a base station configured to perform radio communication in a frequency band within a range of 1 GHz or higher and 300 GHz or lower;
a first reflector configured to reflect a direct wave emitted from the base station; and
a second reflector configured to reflect an electromagnetic wave reflected by the first reflector, wherein
when a maximum gain of a transmitting antenna of the base station is 5 dBi or higher and 30 dBi or lower, a sum total of a first straight-line distance from the base station to the first reflector and a second straight-line distance from the first reflector to the second reflector is 2.5 m or longer and 250.0 m or shorter.

A radio-wave propagation environment is improved by a radio communication system.

The above and other objects, features and advantages of the present disclosure will become more fully understood from the detailed description given hereinbelow and the accompanying drawings.

### BRIEF DESCRIPTION OF THE DRAWINGS

FIG. 1 is a schematic plan view of a radio transmission system according to an embodiment;

FIG. 2 is a schematic view of an electromagnetic-wave reflecting apparatus using a reflector according to an embodiment;

FIG. 3 is a schematic view of an electromagnetic-wave reflecting fence in which a plurality of electromagnetic-wave reflecting apparatuses are connected with one another;

FIG. 4 shows an example of a layer structure of a reflector in the thickness direction thereof;

FIG. 5 is a schematic plan view of an environment used for measuring received power;

FIG. 6 is a schematic plan view showing an arrangement/configuration of a reference example using only one reflector;

FIG. 7 is a schematic plan view of a reflector having a meta-surface;

FIG. 8 shows an example of one of unit patterns 210 constituting the meta-surface; and

FIG. 9 is a schematic plan view showing an arrangement/configuration of a radio transmission system using a reflector having a meta-surface.

### DESCRIPTION OF EMBODIMENT

In an embodiment, a radio transmission system used in an indoor or outdoor environment in which a blind zone(s) occurs is provided. Radio waves in a millimeter-wave band or a sub-terahertz band have, because of their high frequencies, a highly straight-traveling property, a short propagation distance, and a large propagation loss. In facilities such as factories, plants, roads, and commercial facilities, there are various structures and shielding objects, so that it is difficult to maintain high communication quality. Although the radio-wave propagation environment can be improved by using reflectors, the positions, the sizes, and the number of shielding objects are different from one facility to another, so that the efficient arrangement of reflectors cannot be determined in a universal manner. Further, there is a limit on the improvement of a radio-wave propagation environment by using only one reflector.

In an embodiment, a radio transmission system capable of extending an area where the radio-wave propagation environment is improved is provided. A configuration of a radio transmission system according to an embodiment will be described hereinafter with reference to the drawings. The embodiment described below is merely an example to embody the technical concept of the present invention and is not intended to limit the scope of the present invention. The size, the position relationship, and the like of each member shown in the drawings may be exaggerated as appropriate in order to facilitate the understanding of the invention. In the following description, the same components or functions are assigned the same names or symbols, and redundant descriptions thereof may be omitted.

### Radio Transmission System

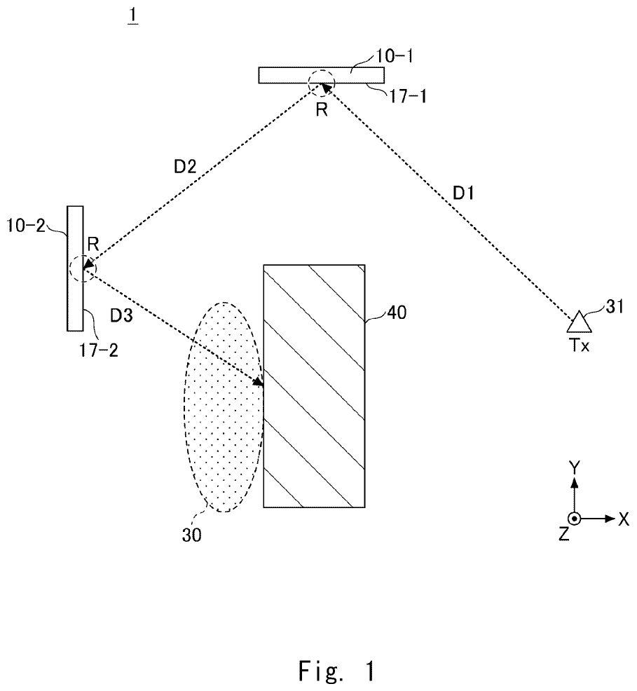

FIG. 1 is a schematic plan view of a radio transmission system 1 according to an embodiment. The radio transmission system 1 includes a base station 31 that is installed indoors or outdoors and performs radio communication at a frequency in a frequency band of 1 GHz or higher and 300 GHz or lower, e.g., 1 GHz or higher and 170 GHz or lower, a first reflector 10-1 that reflects a direct wave emitted from the base station 31, and a second reflector 10-2 that reflects an electromagnetic wave reflected by the first reflector 10-1. In the environment in which the base station 31 is located, there is a structure 40 which blocks the direct wave emitted from the base station 31. In a factory or a plant, the structure 40 may be a metal duct, a pipe, a rack, a production machine, or the like. In the outdoors, the structure 40 may be a building, a signboard, a street tree, or the like. An area located behind the structure 40 as viewed from the base station 31 is a blind zone 30.

The term “blind zone” used in this specification and the claims refers to a zone in which the received power is lowered by 10 dB or more due to the presence of a shielding object such as the structure 40 compared with the surrounding receiving environment in which there is no shielding object. The blind zone 30 includes not only a two-dimensional area but also a three-dimensional space. In the coordinate system shown in FIG. 1, the plane on which the structure 40 is placed is defined as an XY plane, and the height direction orthogonal to the XY plane is defined as a Z direction. When there is a production apparatus equipped with a radio communication function, a sensor, or a user device such as a mobile terminal in the blind zone 30, it becomes difficult to transmit/receive signals to/from the base station 31. Therefore, the radio-wave propagation area is extended by introducing a reflector(s) in the radio transmission system 1.

In the embodiment, an environment in which it is difficult to eliminate the blind zone 30 by using only one reflector is assumed. When the reflector has a specular reflection surface, it is difficult to send a radio wave emitted from the base station 31 to the blind zone 30 by using only one reflector in the arrangement/configuration shown in FIG. 1. Therefore, the first reflector 10-1 is disposed at a such a position where the direct wave emitted from the base station 31 reaches with a certain strength or stronger, and the second reflector 10-2 is disposed at a such a position where the reflected wave from the first reflector 10-1 can be reflected toward the blind zone 30. The second reflector 10-2 may be disposed in an NLOS environment in which the base station 31 cannot be directly seen as long as the reflected wave from the first reflector 10-1 can be made incident thereon.

The straight-line distance from the base station 31 to the first reflector 10-1 (first straight-line distance) is represented by D1, and the straight-line distance from the first reflector 10-1 to the second reflector 10-2 (second straight-line distance) is represented by D2. When the maximum gain of the transmitting antenna (denoted as “Tx” in the drawing) of the base station 31 is 5 dBi or higher and 30 dBi or lower, the sum total of D1 and D2 is 2.5 m or longer and 250.0 m or shorter. When the total distance of D1 and D2 is shorter than 2.5 m, it becomes difficult to efficiently send a radio wave emitted from the base station 31 to the second reflector 10-2 through the first reflector 10-1. When the total distance of D1 and D2 exceeds 250.0 m, it becomes difficult to send a radio wave to the second reflector 10-2 through the first reflector 10-1 with a sufficient reflection strength in consideration of the maximum gain of the transmitting antenna and the straight-traveling property of the radio wave.

When the straight-line distance from the second reflector 10-2 to the boundary of the blind zone 30 (third straight-line distance) is represented by D3, the sum total of D1, D2, and D3 is 5.0 m or longer and 300.0 m or shorter when the maximum gain of the transmitting antenna of the base station 31 is 5 dBi or higher and 30 dBi or lower. When the total distance of D1, D2, and D3 is shorter than 5.0 m, it becomes difficult to efficiently extend the area where the radio-wave propagation environment is improved by sending the radio wave emitted from the base station 31 to the blind zone 30 through the first and second reflectors 10-1 and 10-2. When the total distance of D1, D2, and D3 exceeds 300.0 m, it becomes difficult to send the radio wave to the blind zone 30 through the first and second reflectors 10-1 and 10-2 with a sufficient strength in consideration of the maximum gain of the transmitting antenna and the straight-traveling property of the radio wave.

In order to satisfy the above-described relationship among distances, the first reflector 10-1 is disposed at a position at which it reflects the direct wave emitted from the base station 31, and the second reflector 10-2 is disposed at a position at which it can reflect the reflected wave from the first reflector 10-1 toward the blind zone 30. In this way, it is possible to send the radio wave emitted from the base station 31 to the blind zone 30 with received power by which radio communication can be performed, and thereby to improve the radio-wave propagation environment.

The reflection surface 17-1 of the first reflector 10-1 and the reflection surface 17-2 of the second reflector 10-2 are formed of a material by which an incident radio wave can be reflected in a designed direction while maintaining the strength of the electric field of the incident radio wave as much as possible. In the case where the reflection surfaces 17-1 and 17-2 are specular reflection surfaces, for example, a solid film made of, for example, aluminum, copper, silver, gold, platinum, rhodium, chromium, nickel, or stainless steel can be used. In the case where each of the reflection surfaces 17-1 and 17-2 has an artificial meta-surface that reflects an incident radio wave at an angle different from the incident angle thereof, a mesh, a periodic pattern, or the like is formed by using the aforementioned conductive material. The density of the conductive mesh and the period of the periodic pattern may be designed so as to selectively reflect radio waves (e.g., 28 GHz±4 GHz) emitted from the base station 31.

Regarding the sizes of the reflection surface 17-1 of the first reflector 10-1 and the reflection surface 17-1 of the second reflector 10-2, it is sufficient if they may be large enough to cover at least an area determined by the radius r of the first Fresnel zone. The radius r1 of the first Fresnel zone when the radio wave emitted from the transmitting antenna of the base station 31 and reflected by the first reflector 10-1 reaches the second reflector 10-2 in an in-phase state is defined by the below-shown expression.

$$r 1 = {[ λ \times D 1 \times D 2 / ( D 1 + D 2 ) ]}^{1 / 2}$$

where λ is the operating wavelength of the base station 31.

Similarly, the radius r2 of the first Fresnel zone when the radio wave reflected by the second reflector 10-2 reaches the blind zone 30 in an in-phase state is defined by the below-shown expression.

$$r 2 = {[ λ \times D 2 \times D 3 / ( D 2 + D 3 ) ]}^{1 / 2}$$

When the distance D1 from the antenna of the base station 31 which is operating in a 28 GHz band (wavelength of about 10.7 mm) to the first reflector 10-1 is 10.0 m, and the distance D2 from the first reflector 10-1 to the second reflector 10-2 is 10.0 m, it is sufficient if the length of one side of the reflection surface 17-1 of the first reflector 10-1 is at least about 20 centimeters. Similarly, when the distance D2 from the first reflector 10-1 to the second reflector 10-2 is 10.0 m, and the distance D3 from the second reflector 10-2 to the farthest part of the boundary of the blind zone 30 in the reflecting direction is 10.0 m, it is sufficient if the length of one side of the reflection surface 17-2 of the second reflector 10-2 is at least about 20 centimeters. In a 4.7 GHz band, based on the same relationship in regard to the distances, it is sufficient if one side of each of the first and second reflectors 10-1 and 10-2 is fifty-odd centimeters. Further, when the distance is shorter, it is sufficient if one side is 20 centimeters or shorter. Meanwhile, in order to cover as large a reflection area as possible with a small number of reflectors 10, the size of the reflection surface of at least one of the first and second reflectors 10-1 and 10-2 may be extended to a size of about 3.0 m×3.0 m. In the embodiment, the blind zones 30 are reduced and the radio propagation area is thereby extended by disposing two or more reflectors each of which has a size of 0.1 m×0.1 m to 3.0 m×3.0 m.

The positions of the reflection centers R of the reflection surfaces 17-1 and 17-2 of the first and second reflectors 10-1 and 10-2 are determined based on the position, height, and maximum gain of the transmitting antenna of the base station 31 as well as the position and spatial range of the blind zone 30. It is desirable that the reflection center R is, for example, at a height of 0.5 m or higher from the floor or road surface where the reflector 10 is installed. The inclination of the first reflector 10-1 or the second reflector 10-2 relative to the floor or road surface and the angle with respect to the line-of-sight (LOS: Line-of-Sight) of the base station 31 are determined as appropriate according to the shape of the beam formed by the antenna of the base station 31, the emitting angles in the horizontal direction and in the vertical direction of the beam, the position of the blind zone 30, and the like.

At least one of the first and second reflectors 10-1 and 10-2 may have a meta-surface which reflects an incident electromagnetic wave at an angle different from the incident angle thereof on at least a part of its reflection surface. Alternatively, at least one of the first and second reflectors 10-1 and 10-2 may have a specular reflection surface which reflects an incident electromagnetic wave at the same angle as the incident angle thereof on at least a part of its reflection surface.

### Electromagnetic Wave Reflecting Apparatus and Electromagnetic Wave Reflecting Fence Using Reflector

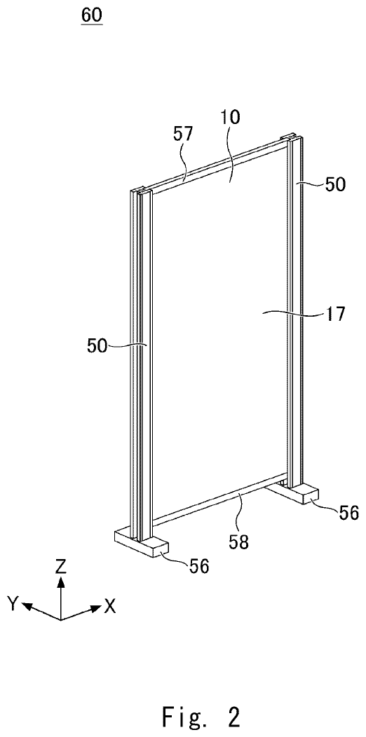

FIG. 2 is a schematic diagram of an electromagnetic-wave reflecting apparatus 60 including a reflector 10 according to an embodiment. The plane on which the electromagnetic-wave reflecting apparatus 60 is installed is defined as an XY plane, and the height direction orthogonal to the XY plane is defined as a Z direction. The electromagnetic-wave reflecting apparatus 60 includes the reflector 10 which reflects an electromagnetic wave having a frequency equal to the operating frequency of the base station 31, and is disposed at a place that is considered to be a place where it is necessary to install such a reflector 10 in the communication area of the base station 31.

The electromagnetic-wave reflecting apparatus 60 may include frames 50 for holding both ends of the reflector 10, a top frame 57 for holding the upper end thereof, and a bottom frame 58 for holding the lower end thereof. The frames 50, the top frame 57, and the bottom frame 58 hold the entire periphery of the reflector 10. The frames 50 may be called “side frames” because of the positional relationship with the top frame 57 and the bottom frame 58. The top frame 57 and the bottom frame 58 are not indispensable. However, by providing the top frame 57 and the bottom frame 58, it is possible to ensure the mechanical strength and safety of the reflector 10 when the reflector 10 is conveyed, assembled, or installed.

When the electromagnetic-wave reflecting apparatus 60 is to be made to stand alone indoors or outdoors, legs 56 may be provided. Although the legs 56 support the lower end of the frames 50 in the example shown in FIG. 2, the legs 56 may be connected to the bottom frame 58. The legs 56 may be fixed to the floor or road surface with screws or the like. The legs 56 may be equipped with movable components such as casters so that they can be moved in the place where the reflector is installed. The legs 56 may not be provided, and the entire periphery of the reflector 10 may be surrounded by frames, and the reflector 10 may be installed parallel to the wall, ceiling, floor, or the like, or obliquely to the wall, ceiling, floor, or the like.

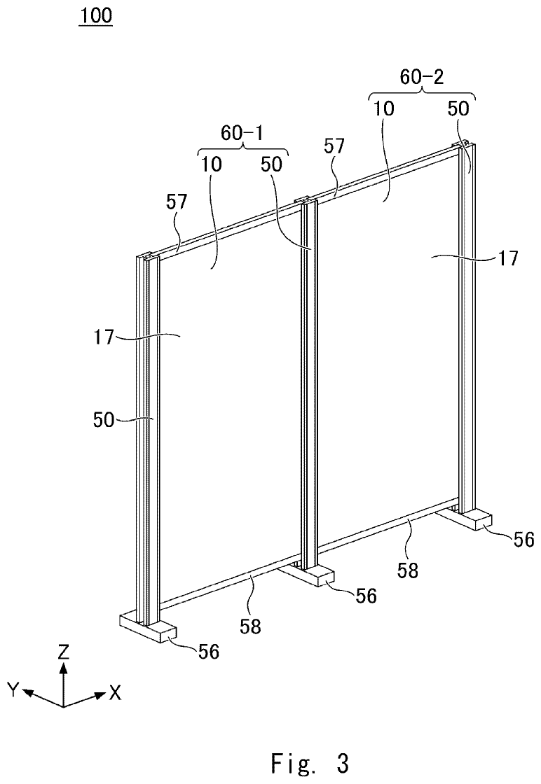

FIG. 3 is a schematic diagram of an electromagnetic-wave reflecting fence 100 in which electromagnetic-wave reflecting apparatuses 60-1 and 60-2 are connected to each other by frames 50. Reflectors 10 of the electromagnetic-wave reflecting apparatuses 60-1 and 60-2 are held by the frames 50. Each reflector 10 may have a non-specular reflection surface on which the incident angle and the reflection angle of an electromagnetic wave are different from each other in at least a part of thereof. The non-specular reflection surface includes a meta-surface, which is an artificial reflection surface designed to reflect an electromagnetic wave in a desired direction, in addition to a diffusing surface and a scattering surface. In some cases, it is desirable that the reflection surfaces 17 of the reflectors 10 adjacent to each other are electrically connected to each other in order to maintain the continuity of the reflection potential. However, in the case where a meta-surface is included in the non-specular reflection surface, the electrical connection between the reflection surfaces 17 of the reflectors 10 adjacent to each other may be unnecessary. By holding reflectors 10 adjacent to each other by the frames 50, an electromagnetic-wave reflecting fence 100 in which reflectors are connected to each other in the X direction is obtained. The connected electromagnetic-wave reflecting fence 100 (i.e., the electromagnetic-wave reflecting fence 100 in which the reflectors are connected to each other) may be used as a first reflector 10-1 or a second reflector 10-2. In this way, the area where the radio quality is improved can be extended.

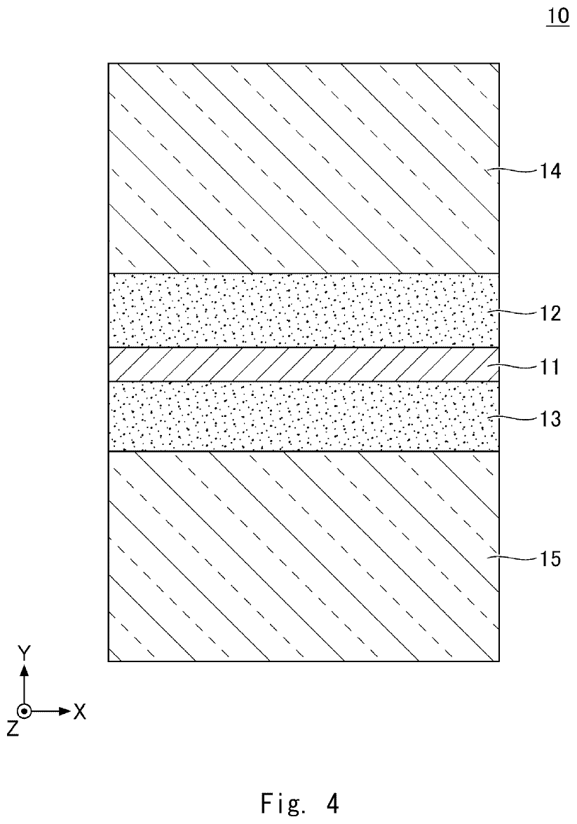

FIG. 4 shows a layer structure of the reflector 10 in the thickness direction (Y direction). The reflector 10 includes a conductive layer 11, and a dielectric layer 14 or 15 joined to at least one of the surfaces of the conductive layer 11 with an adhesive layer 12 or 13 interposed therebetween. In the example shown in FIG. 4, the conductive layer 11 is interposed between the dielectric layers 14 and 15 with the adhesive layers 12 and 13 respectively interposed therebetween. In the case where the reflector 10 is used outdoors, a protective layer such as an ultraviolet-light protection film may be provided on at least one of the dielectric layers 14 and 15. In general, when a reflector 10 is placed in an outdoor environment, the surface substrate of the reflector 10 tends to be deformed, discolored, deteriorated, or the like due to visible light and ultraviolet light contained in sunlight, temperature changes, and the like. In the case where the dielectric layers 14 and 15 disposed on the surfaces of the reflector 10 are resin substrates, they are likely to be affected by temperature changes or the like. When the dielectric layers 14 or 15 are deformed by an amount about 1/100 of the original size, the reflecting direction or reflection efficiency may change. Further, the relative dielectric constant of the resin material or the dielectric material may change due to the irradiation of ultraviolet light, so that the reflecting direction and reflection efficiency may deviate from the designed ones. From this point of view, depending on the place where the reflector 10 is installed, it is desirable to provide a protective layer on the surface of either or both of the dielectric layers 14 and 15.

The conductive layer 11 serves as a surface that forms the reflection surface 17 of the reflector 10 and may be formed of a metal mesh, a periodic pattern, a geometric pattern, a transparent conductive film, or the like. As an example, the conductive layer 11 includes a metal mesh formed of a good conductor such as Cu, Ni, SUS, Ag, or the like. When the reflection surface 17 includes a meta-surface in a part thereof, the conductive layer 11 may include a pattern that includes a periodic array of a plurality of metal elements. The conductive layer 11 has a thickness of 10 μm or thicker and 200 μm or thinner, preferably 50 μm or thicker and 150 μm or thinner, so as to sufficiently function as a reflection surface that reflects an electromagnetic wave having a desired frequency in a designed direction.

The adhesive layers 12 and 13 have a transmittance of 60% or higher, preferably 70% or higher, and more preferably 80% or higher for the used frequency so as to guide the incident electromagnetic wave to the conductive layer 11. The adhesive layers 12 and 13 may be made of vinyl acetate resin, acrylic resin, cellulose resin, aniline resin, ethylene resin, silicon resin, or other resin materials. An ethylene-vinyl acetate (EVA: ethylene-vinyl acetate) copolymer or a cycloolefin polymer (COP) may be used in order to make the adhesive layers 12 and 13 durable and moisture-resistant for outdoor use. The thickness of each of the adhesive layers 12 and 13 is such a thickness that the dielectric layers 14 and 15 can be reliably bonded to and held by the conductive layer 11, and is, for example, 10 μm or thicker and 400 μm or thinner. The adhesive layers 12 and 13 have a dielectric constant and a dielectric tangent suitable for achieving the target reflection characteristic of the conductive layer 11.

Each of the dielectric layers 14 and 15 is an insulating polymer film made of a polymer material such as polycarbonate, cycloolefin polymer (COP), polyethylene terephthalate (PET), and fluorocarbon resin. In order to make the total amount of the reflector 10 as light as possible while maintaining the strength of the reflector 10, the thickness of each of the dielectric layers 14 and 15 is selected in a range of thicker than 1.0 mm and not thicker than 10.0 mm. When the thickness of the conductive layer 11 is set to 100.0 μm, the ratio of the thickness of each of the dielectric layers 14 and 15 to the thickness of the conductive layer 11 is higher than 10 and not higher than 80. By setting the ratio of the thickness of each of the dielectric layers 14 and 15 to the thickness of the conductive layer 11 in the aforementioned range, the reflector 10 has a mechanical strength strong enough to withstand outdoor use, and hence the target reflection characteristic can be achieved. When a priority is put on the mechanical strength, the ratio of the thickness of the dielectric material to the conductive layer 11 is increased. When the reflector 10 includes a meta-surface in this situation, it is desirable to appropriately design the relative permittivity and dielectric tangent of the entire dielectric part consisting of the adhesive layer 12 and dielectric layer 14, or the adhesive layer 13 and dielectric layer 15.

### Evaluation of Reflector and Radio Transmission System

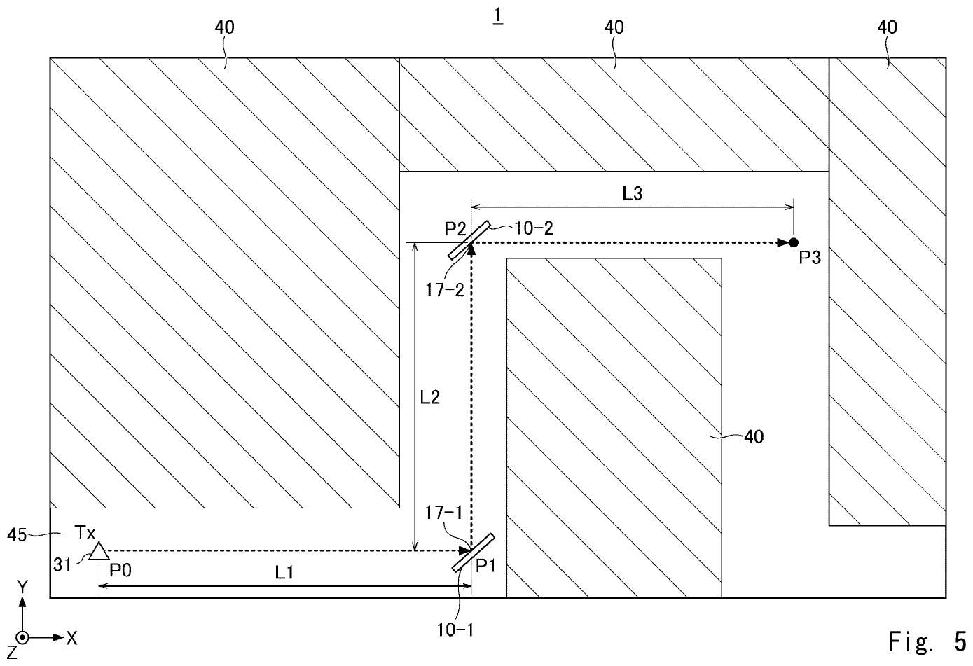

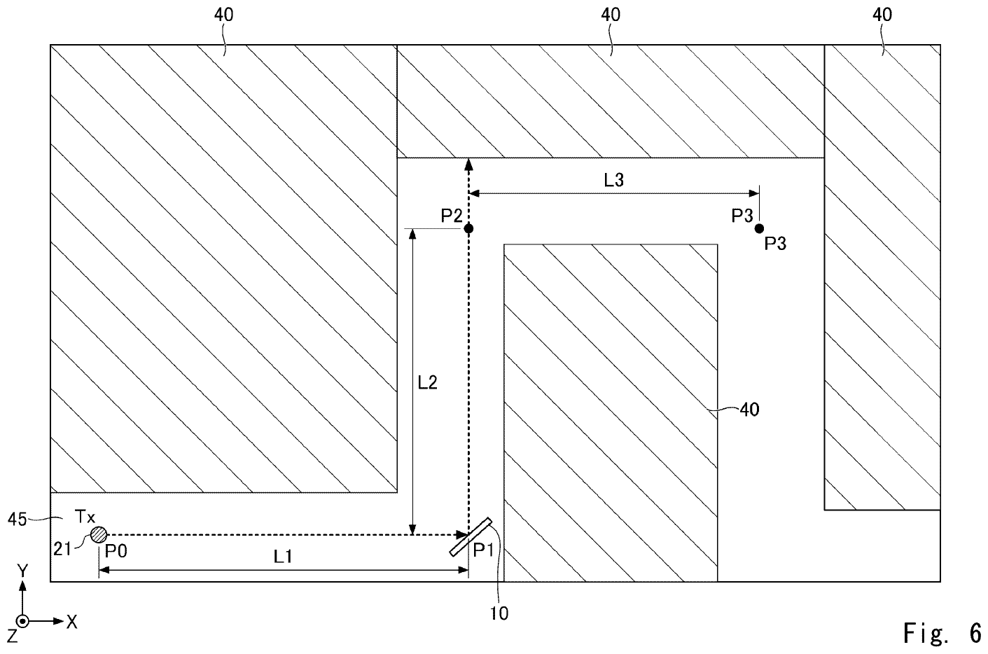

A distribution of received power in an environment in which there are shielding objects is measured by using two or more reflectors described above. FIG. 5 is a schematic plan view of an environment used for the measurement of received power. FIG. 6 shows, as a reference example, a schematic plan view of an arrangement/configuration using only one reflector. In FIGS. 5 and 6, a passage 45 including parts in which view is poor is provided between walls, which are structures 40. A base station 31 is installed at a position P0 in the passage 45. The transmitting antenna Tx of the base station 31 is installed at a height of 1.0 m, and a beam of Sub6 (4.7 GHz) which is directive in the X direction is emitted therefrom at an angle parallel to the XY plane. The half-width of the beam is about 10°. The passage 45 bends 90 degrees at a part thereof a predetermined distance away from the position PO of the base station 31 in the X direction, and extends therefrom a predetermined distance in the Y direction. Further, the passage bends toward the X direction and extends a predetermined distance. In this planar arrangement, the received power is measured before and after the installation of the reflector(s) by using a measuring device including a receiving antenna disposed at a height of 1.0 m, and the change in the received power therebetween is observed.

### Example 1

Example 1 is Implementation Example 1 (i.e., Example 1 according to the present disclosure). A passage 45 having a width of 7.0 m extends 30.0 m from a position PO in the X direction, bends 90° toward the Y direction, and extends 30.0 m in the Y direction. Further, the passage bends 90° toward X direction and extends 30.0 m in the X direction. A first reflector 10-1 having a height of 2.0 m and a width of 1.0 m is disposed at a position P1 30.0 m away from the transmitting antenna Tx of the base station 31 in the X direction at an angle of 45° with respect to the line of sight of the base station 31. A second reflector 10-2 having a height of 2.0 m and a width of 1.0 m is disposed parallel to the first reflector 10-1 at a position P2 30.0 m away from the position P1 in the Y direction. A position 30.0 m away from the second reflector 10-2 in the X direction is defined as a position P3. As viewed from the first reflector 10-1, the area from the position P2 to the position P3 is a blind zone, and the farthest part of the boundary of the blind zone in the reflecting direction of the second reflector 10-2 is located at the position P3. From the position P0 to the position P3, the received power is measured at intervals of 1.0 m in the X direction and in the Y direction. The total distance L1+L2+L3 from the position P0 to the position P3 is 90 m. The first and second reflectors 10-1 and 10-2 have reflection surfaces 17-1 and 17-2, respectively, which specularly reflect radio waves or the like. The maximum gain of the antenna of the base station 31 is 20 dBi.

In the part of the passage between the positions P1 and P2 (L2=30.0 m), the average received power before installing the first reflector 10-1 is −90.0 dBm. It is confirmed that the average received power in this part of the passage increases to −70.0 dBm, i.e., is improved by 20.0 dB, by installing the first reflector 10-1 at the position P1. Further, in the part of the passage between the positions P2 and P3 (L3=30.0 m), the average received power before installing the first and second reflectors 10-1 and 10-2 is −100.0 dBm. It is confirmed that the average received power of the part of the passage between P2 and P3 increases to −75.0 dBm, i.e., is improved by 25.0 dB, by installing the first reflector 10-1 at the position P1 and the second reflector 10-2 at the position P2.

### Example 2

Example 2 is Implementation Example 2. The specifications of the passage 45 are the same as those of Example 1. Two reflectors 10 each having a height of 2.0 m and a width of 1.0 m are disposed at a position P1 30.0 m away from the transmitting antenna Tx of the base station 31 in the X direction at an angle of 45° with respect to the line of sight of the base station 31. The two reflectors 10 are connected to each other in the width direction by a frames 50 as shown in FIG. 3, so that a first reflector 10-1 having a height of 2.0 m and a width of 2.0 m is formed. The two reflectors 10 connected to each other have specular reflection surfaces and are electrically connected to each other by the frames 50 so that the reflection potentials become continuous.

A second reflector 10-2 having a height of 2.0 m and a width of 1.0 m is disposed parallel to the first reflector 10-1, which has the size of 2.0 m×2.0 m, at a position P2 30.0 m away from the position P1 in the Y direction. The second reflector 10-2 has a specular reflection surface. A position 30.0 m away from the second reflector 10-2 in the X direction is defined as a position P3. From the position P0 to the position P3, the received power is measured at intervals of 1.0 m in the X direction and in the Y direction. The total distance L1+L2+L3 from the position P0 to the position P3 is 90 m. The maximum gain of the antenna of the base station 31 is 20 dBi.

In the part of the passage between the positions P1 and P2 (L2=30.0 m), the average received power before installing the first reflector 10-1 is −90.0 dBm, and it is confirmed that the average received power in this part of the passage increases to −65.0 dBm, i.e., is improved by 25.0 dB, by installing the first reflector 10-1 having the size of 2.0 m×2.0 m at the position P1. In the part of the passage between the positions P2 and P3 (L3=30.0 m), the average received power before installing the first and second reflectors 10-1 and 10-2 is −100.0 dBm. It is confirmed that the average received power of the part of the passage between P2 and P3 increases to −75.0 dBm, i.e., is improved by 25.0 dB, by installing the first reflector 10-1 having the size of 2.0 m×2.0 m at the position P1 and the second reflector 10-2 having the size of 2.0 m×1.0 m at the position P2.

### Example 3

Example 3 is Comparative Example 1 for Implementation Example 1. As shown in FIG. 6, the specifications of the passage 45 are the same as those of Implementation Example 1. In the arrangement/configuration shown in FIG. 6, a first reflector 10-1 having a height of 2.0 m and a width of 1.0 m is disposed at a position P1 30.0 m away from the transmitting antenna Tx of the base station 31 in the X direction at an angle of 45° with respect to the line of sight of the base station 31. Only the first reflector 10-1 is used, and no reflector is placed at the position P2. A position 30.0 m away from the position P2 in the X direction is defined as a position P3. From the position P0 to the position P3, the received power is measured at intervals of 1.0 m in the X direction and in the Y direction. The total distance L1+L2+L3 from the position P0 to the position P3 is 90 m. The first reflector 10-1 has a reflection surface 17-1 that specularly reflects radio waves or the like. The maximum gain of the antenna of the base station 31 is 20 dBi.

In the part of the passage between the positions P1 and P2 (L2=30.0 m), the average received power before installing the first reflector 10-1 is −90.0 dBm, and it is confirmed that the average received power in this part of the passage increases to −70.0 dBm, i.e., is improved by 20.0 dB, by installing the first reflector 10-1 at the position P1. In the part of the passage between the positions P2 and P3 (L3=30.0 m), the average received power before installing the first reflector 10-1 is −100.0 dBm. The average received power between the positions P2 and P3 after the first reflector 10-1 is installed at the position PI is −100.0 dBm, meaning that the radio-wave propagation environment in this part of the passage is not improved by installing only the first reflector 10-1. This is because the radio wave reflected by the first reflector 10-1 travels straight through the position P2 and is scattered by the structure 40 forming the wall.

### Example 4

Example 4 is Comparative Example 2 for Implementation Example 2. Two reflectors 10 each having a height of 2.0 m and a width of 1.0 m are disposed at a position P1 30.0 m away from the transmitting antenna Tx of the base station 31 in the X direction at an angle of 45° with respect to the line of sight of the base station 31. The two reflectors 10 are connected to each other in the width direction by a frames 50 as shown in FIG. 3, so that a first reflector 10-1 having a height of 2.0 m and a width of 2.0 m is formed. The two reflectors 10 connected to each other have specular reflection surfaces and are electrically connected to each other by the frames 50 so that the reflection potentials become continuous.

Only the first reflector 10-1 having the size of 2.0 m×2.0 m placed at the position P1 is used, and no reflector is placed at the position P2. A position 30.0 m away from the position P2 in the X direction is defined as a position P3. From the position P0 to the position P3, the received power is measured at intervals of 1.0 m in the X direction and in the Y direction. The total distance L1+L2+L3 from the position P0 to the position P3 is 90 m. The maximum gain of the antenna of the base station 31 is 20 dBi.

In the part of the passage between the positions P1 and P2 (L2=30.0 m), the average received power before installing the first reflector 10-1 is −90.0 dBm, and it is confirmed that the average received power in this part of the passage increases to −65.0 dBm, i.e., is improved by 25.0 dB, by installing the first reflector 10-1 having the size of 2.0 m×2.0 m at the position P1. In the part of the passage between the positions P2 and P3 (L3=30.0 m), the average received power before installing the first reflector 10-1 is −100.0 dBm. The average received power between the positions P2 and P3 after installing the first reflector 10-1 having the size of 2.0 m×2.0 m at the position P1 is −100.0 dBm, meaning that the radio-wave propagation environment in this part of the passage is not improved by installing only the first reflector 10-1 in which two reflectors are connected to each other.

### Example 5

Example 5 is Implementation Example 3. In Implementation Example 3, a radio-wave propagation environment is improved in a relatively narrow closed space such as a warehouse. In the arrangement/configuration shown in FIG. 5, the distance L1 between the positions P0 and P1 is set to 2.0 m; the distance L2 between the positions P1 and P2 is set to 3.0 m; and the distance L3 between the positions P2 and P3 is set to 5.0 m. The width of the passage 45 is 3.0 m. A base station is installed at the position P0. The maximum gain of the antenna of the base station 31 is 10 dBi.

A first reflector 10-1 having a height of 2.0 m and a width of 1.0 m is disposed at a position P1 2.0 m away from the transmitting antenna Tx of the base station 31 in the X direction at an angle of 45° with respect to the line of sight of the base station 31. A second reflector 10-2 having a height of 2.0 m and a width of 1.0 m is disposed parallel to the first reflector 10-1 at a position P2 3.0 m away from the position P1 in the Y direction. A position 5.0 m away from the second reflector 10-2 in the X direction is defined as a position P3. From the position P0 to the position P3, the received power is measured at intervals of 1.0 m in the X direction and in the Y direction. The total distance L1+L2+L3 from the position P0 to the position P3 is 10.0 m. The first and second reflectors 10-1 and 10-2 have reflection surfaces 17-1 and 17-2, respectively, which specularly reflect radio waves or the like.

In the part of the passage between the positions P1 and P2 (L2=3.0 m), the average received power before installing the first reflector 10-1 is −75.0 dBm, and it is confirmed that the average received power in this part of the passage increases to −70.0 dBm, i.e., is improved by 5.0 dB, by installing the first reflector 10-1 at the position P1. In the part of the passage between the positions P2 and P3 (L3=5.0 m), the average received power before installing the first and second reflectors 10-1 and 10-2 is −95.0 dBm, and it is confirmed that the average received power in this part of the passage increases to −70.0 dBm, i.e., is improved by 25.0 dB, by installing the first and second reflectors 10-1 and 10-2. When the distance from the base station 31 to the first reflector 10-1 is short, i.e., is 2.0 m, the received power in the part of the passage between the positions P1 and P2 is not so low even when the first reflector 10-1 is not installed, so that the improving ratio of the received power is somewhat lower than those of Implementation Examples 1 and 2.

### Example 6

Example 6 is Implementation Example 4. In Implementation Example 4, a radio-wave propagation environment is improved in a larger environment such as a train station or a shopping mall. In the arrangement/configuration shown in FIG. 5, the distance L1 between the positions P0 and P1 is set to 150.0 m; the distance L2 between the positions P1 and P2 is set to 100.0 m; and the distance L3 between the positions P2 and P3 is set to 50.0 m. The width of the passage 45 is 12.0 m. A base station 31 is installed at the position P0. The maximum gain of the antenna of the base station 31 is 30 dBi.

Three reflectors 10 each having a height of 2.0 m and a width of 1.0 m are connected to one another as shown in FIG. 3 and used as a first reflector 10-1, and installed at a position P1 150.0 m away from the transmitting antenna Tx of the base station 31 in the X direction at an angle of 45° with respect to the line of sight of the base station 31. Two reflectors 10 each having a height of 2.0 m and a width of 1.0 m are connected to one another as shown in FIG. 3 and used as a second reflector 10-2, and installed parallel to the first reflector 10-1 at a position P2 100.0 m away from the position P1 in the Y direction. A position 50.0 m away from the second reflector 10-2 in the X direction is defined as a position P3. From the position P0 to the position P3, the received power is measured at intervals of 1.0 m in the X direction and in the Y direction. The total distance L1+L2+L3 from the position P0 to the position P3 is 300.0 m. The first and second reflectors 10-1 and 10-2 have reflection surfaces 17-1 and 17-2, respectively, which specularly reflect radio waves or the like.

In the part of the passage between the positions P1 and P2 (L2=100.0 m), the average received power before installing the first reflector 10-1, in which three reflectors are connected to one another, is −100.0 dBm, and it is confirmed that the average received power in the part of the passage between the positions P1 and P2 increases to −70.0 dBm, i.e., is improved by 30.0 dB, by installing the first reflector 10-1, in which three reflectors are connected to one another, at the position P1. In the part of the passage between the positions P2 and P3 (L3=50.0 m), the average received power before installing the first and second reflectors 10-1 and 10-2 is −100.0 dBm, and it is confirmed that the average received power in this part of the passage increases to −75.0 dBm, i.e., is improved by 25.0 dB, by installing the first and second reflectors 10-1 and 10-2. The improving ratio in the received power is higher than that in Example 6.

### Example 7

Example 7 is Comparative Example 3. In Comparative Example 3, in the arrangement/configuration shown in FIG. 5, the distance L1 between the positions P0 and P1 is set to 200.0 m; the distance L2 between the positions P1 and P2 is set to 200.0 m; and the distance L3 between the positions P2 and P3 is set to 100.0 m. The width of the passage 45 is 15.0 m. A base station 31 is installed at the position P0. The maximum gain of the antenna of the base station 31 is 30.0 dBi.

Three reflectors 10 each having a height of 2.0 m and a width of 1.0 m are connected to one another as shown in FIG. 3 and used as a first reflector 10-1, and installed at a position P1 200.0 m away from the transmitting antenna Tx of the base station 31 in the X direction at an angle of 45° with respect to the line of sight of the base station 31. Two reflectors 10 each having a height of 2.0 m and a width of 1.0 m are connected to one another as shown in FIG. 3 and used as a second reflector 10-2, and disposed parallel to the first reflector 10-1 at a position P2 200.0 m away from the position P1 in the Y direction. A position 100.0 m away from the second reflector 10-2 in the X direction is defined as a position P3. From the position P0 to the position P3, the received power is measured at intervals of 1.0 m in the X direction and in the Y direction. The total distance L1+L2 from the position P0 to the position P2 is 400 m, and the total distance L1+L2+L3 from the position P0 to the position P3 is 500 m. The first and second reflectors 10-1 and 10-2 have reflection surfaces 17-1 and 17-2, respectively, which specularly reflect radio waves or the like.

In the part of the passage between the positions P1 and P2 (L2=200.0 m), the average received power before installing the first reflector 10-1, in which three reflectors are connected to one another, is −120.0 dBm. Even when the first reflector 10-1, in which three reflectors are connected to one another, is installed at the position P1, the average received power in the same part of the passage is −120.0 dBm, meaning that no improvement is made. It is presumed that this is because the direct wave does not enter the first reflector 10-1 with a sufficient strength because of the relation with the maximum gain of the antenna of the base station 31, and therefore the radio wave cannot be reflected in the direction toward the position P2. Further, in the part of the passage between the positions P2 and P3 (L3=100.0 m), the average received power before installing the first and second reflectors 10-1 and 10-2 is −120.0 dBm. Even when the first and second reflectors 10-1 and 10-2 are installed, the average received power in the part of the passage between the positions P2 and P3 is −120.0 dBm, meaning that no improvement is made.

According to Examples 1 to 7, it is possible to efficiently send a radio wave to the blind zone by installing the first and second reflectors 10-1 and 10-2 in an appropriate distance range from the base station 31 and thereby reflecting the radio wave reflected by the first reflector 10-1 toward the blind zone by the second reflector 10-2. Further, the area where the radio-wave propagation environment is improved can be extended more efficiently by disposing, within the range where the direct wave of the base station 31 reaches, the first reflector 10-1 at a position some distance away from the base station 31 compared with the case where the distance L1 from the base station 31 to the first reflector 10-1 and the distance L2 from the first reflector 10-1 to the second reflector 10-2 are short. The results of Examples 1 to 7 hold true when the operating frequency of the base station 31 is 1 GHz or higher and 10 GHz or lower, preferably 5 GHz±3 GHz.

### Example of Arrangement/Configuration Using Meta-Surface

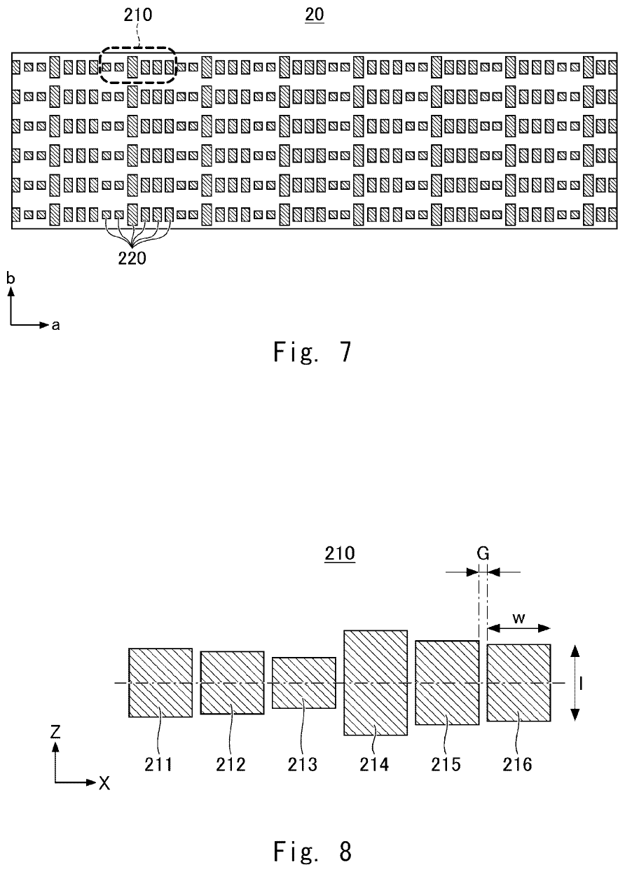

FIG. 7 is a schematic plan view of a reflector 20 having a meta-surface, and FIG. 8 shows an example of one of unit patterns 210 constituting the meta-surface. On the meta-surface of the reflector 20, unit patterns 210 each of which consists of a plurality of conductive elements 220 are arranged in a repeated manner in an a-direction and in a b-direction. The a-direction corresponds to the X direction in FIG. 2, and the b-direction corresponds to the Z direction in FIG. 2. As shown in FIG. 8, the unit pattern 210, i.e., each unit pattern 210, includes, for example, six conductive elements 211, 212, 213, 214, 215, and 216.

Each of the conductive elements 211 to 216 has a long axis in the Z direction. Further, their widths (w) in the X direction are equal to each other, and their lengths (l) in the Z direction are different from each other. The conductive elements 211 to 216 are arranged at a predetermined pitch in the X direction with intervals G between conductive elements adjacent to each other. Although the unit pattern 210 is designed so as to reflect an electromagnetic wave in a 28 GHz band, which is perpendicularly incident thereon, at an angle of 50° in the example shown in FIG. 8, the design of the unit pattern 210 is not limited to this example. It is possible to design the reflection phase so as to reflect the incident electromagnetic wave in a desired direction by designing the shape, interval G, length (l), and the like of each of the conductive elements constituting the unit pattern 210.

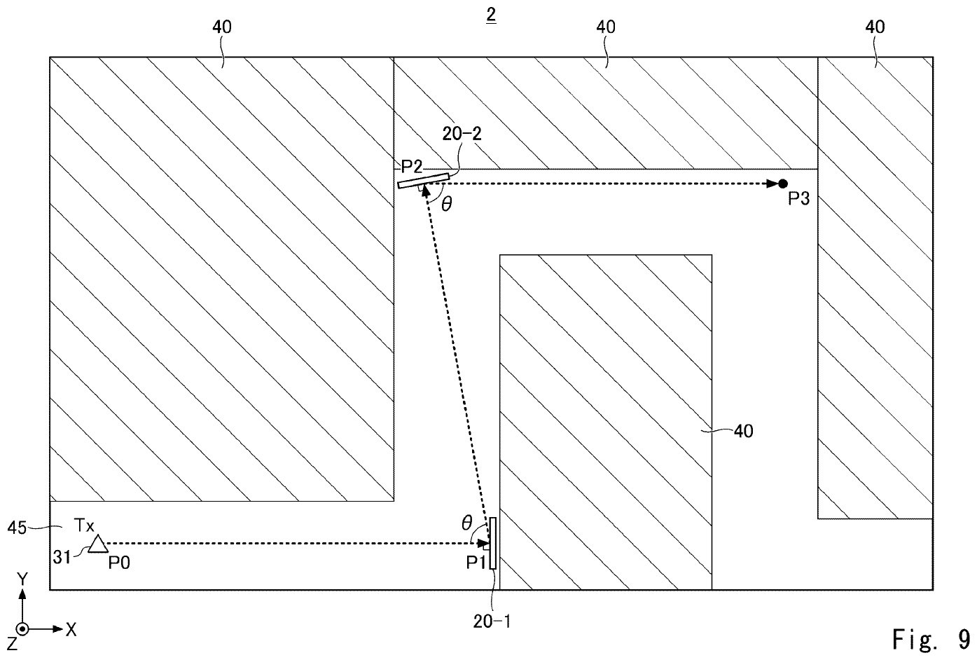

FIG. 9 is a schematic plan view showing an arrangement/configuration of a radio transmission system 2 using a reflector 20 having a meta-surface. The arrangement of the passage 45 defined by walls, which are structures 40, is identical to that shown in FIGS. 5 and 6. A base station 31 is installed at a position P0 in the passage 45. The transmitting antenna Tx of the base station 31 is installed at a height of 1.0 m, and a beam in a 28 GHz band, which is directive in the X direction, is emitted therefrom at an angle parallel to the XY plane. The half-width of the beam is about 10°.

A first reflector 20-1 having a meta-surface having a height of 2.0 m and a width of 1.0 m is disposed at a position P1 30.0 m away from the transmitting antenna Tx of the base station 31 in the X direction at a right angle with respect to the line of sight of the base station 31. The direct wave emitted from the base station 31 is perpendicularly incident on the first reflector 20-1 and reflected at a designed reflection angle θ. By using the first reflector 20-1 having the meta-surface, the space in which the reflector is disposed is reduced and hence the efficiency of the use of the space is improved compared with the specular-reflective first reflector 10-1 used at the same position and the angle of 45° shown in FIG. 5.

The electromagnetic wave reflected by the first reflector 20-1 is incident on a second reflector 20-2 disposed at a position P2 at an angle close to the right angle. The straight-line distance between the positions P1 and P2 is slightly longer than the propagation distance of 30.0 m shown in FIG. 5. The electromagnetic wave incident on the second reflector 20-2 is reflected in the direction toward a position P3 at the designed reflection angle 0. Although the second reflector 20-2 is disposed so that the electromagnetic wave reflected in a non-specular manner by the first reflector 20-1 is incident thereon at an incident angle close to 0° in this example, the second reflector 20-2 may be disposed so the electromagnetic wave is incident at a predetermined incident angle larger than 0° in consideration of the space in which the second reflector 20-2 is installed. Even in this case, the incident electromagnetic wave is reflected in the direction toward the position P3 at a reflection angle different from the incident angle.

When the first reflector 20-1 is not installed, the area or space from the position P1 to the position P2 becomes a blind zone in which the received power is lower by 10 dB or more than that in the surrounding environment in which there are no shielding objects. It is possible to eliminate the blind zone while saving the space in which the reflector is installed by providing the first reflector 20-1. When the second reflector 20-2 is not installed, the area or space from the position P2 to the position P3 becomes a blind zone in which the received power is lower by 10 dB or more than that in the surrounding environment in which there are no shielding objects. It is possible to eliminate the blind zone while saving the space in which the reflector is installed by providing the second reflector 20-2.

Although a radio transmission system according to an embodiment has been described based on specific configuration examples, the present invention is not limited to the configuration examples described above. The sizes of the reflection surfaces of the first and second reflectors can be designed as appropriate according to the situation in which they are used, and as an example, those having a plane size of 0.1 m×0.1 m to 3.0 m×3.0 m may be used. The first or second reflector may be formed by connecting two or more reflectors. In this case, the plane size of each of the reflectors connected to one another may be selected in a range of 0.1 m×0.1 m to 3.0 m×3.0 m.

At least one of the first and second reflectors may have a meta-surface which reflects the incident electromagnetic wave at an angle different from the incident angle thereof on at least a part of its reflection surface. Further, at least one of the first and second reflectors may have a specular reflection surface which specularly reflects the incident electromagnetic wave on at least a part of its reflection surface. At least one of the first and second reflectors may include a protective layer for blocking ultraviolet light in the outermost layer. The height of the antenna of the base station 31 is not limited to 1.0 m. That is, the antenna may be provided at a height of 0.3 m to 5.0 m depending on the place where the antenna is installed. Depending on the position of the antenna of the base station 31, the reflection surface of either or both of the first and second reflectors may be installed at such an angle that the reflection surface reflects the incident electromagnetic wave obliquely upward. It is possible to eliminate a blind zone which would otherwise be not eliminated by using only one reflector by reflecting the electromagnetic wave reflected by the first reflector toward the blind zone by the second reflector.

Embodiments according to the present disclosure have been described above, and the present disclosure may include configurations described hereinafter.

### (Item 1)

A radio transmission system comprising:
a base station configured to perform radio communication in a frequency band within a range of 1 GHz or higher and 300 GHz or lower;
a first reflector configured to reflect a direct wave emitted from the base station; and
a second reflector configured to reflect an electromagnetic wave reflected by the first reflector, wherein
when a maximum gain of a transmitting antenna of the base station is 5 dBi or higher and 30 dBi or lower, a sum total of a first straight-line distance from the base station to the first reflector and a second straight-line distance from the first reflector to the second reflector is 2.5 m or longer and 250.0 m or shorter.

### (Item 2)

The radio transmission system described in Item 1, wherein a sum total of the first straight-line distance, the second straight-line distance, and the third straight-line distance from the second reflector to a farthest part of a boundary of a blind zone in a reflecting direction of the reflector is 5.0 m or longer and 300.0 m or shorter.

### (Item 3)

The radio transmission system described in Item 1 or 2, wherein the second reflector is installed in an NLOS environment in which the base station cannot be directly seen.

(Item 4) The radio transmission system described in any one of Items 1 to 3, wherein at least one of the first and second reflectors is formed by connecting a plurality of reflectors with one another.

### (Item 5)

The radio transmission system described in any one of Items 1 to 3, wherein a plane size of the first or second reflector is 0.1 m×0.1 m or larger and 3.0 m×3.0 m or smaller.

### (Item 6)

The radio transmission system described in Item 4, wherein a plane size of each of the plurality of reflectors is selected in a range of 0.1 m×0.1 m or larger and 3.0 m×3.0 m or smaller.

### (Item 7)

The radio transmission system described in any one of Items 1 to 6, wherein at least one of the first and second reflectors includes a meta-surface on at least a part of its reflection surface, the meta-surface being configured to reflect an incident electromagnetic wave at an angle different from an incident angle thereof.

### (Item 8)

The radio transmission system described in any one of Items 1 to 6, wherein at least one of the first and second reflectors includes a specular reflection surface on at least a part of its reflection surface, the specular reflection surface being configured to specularly reflect an incident electromagnetic wave.

### (Item 9)

The radio transmission system described in any one of Items 1 to 8, wherein at least one of the first and second reflectors includes a protective layer on an outermost layer, the protective layer being configured to block ultraviolet light.

### (Item 10)

The radio transmission system described in any one of Items 1 to 9, wherein the transmitting antenna of the base station is installed at a height of 0.5 m or higher and 5.0 m or lower from a floor or a road surface.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A radio transmission system comprising:
a base station configured to perform radio communication in a frequency band within a range of 1 GHz or higher and 300 GHz or lower;
a first reflector configured to reflect a direct wave emitted from the base station; and
a second reflector configured to reflect an electromagnetic wave reflected by the first reflector, wherein
when a maximum gain of a transmitting antenna of the base station is 5 dBi or higher and 30 dBi or lower, a sum total of a first straight-line distance from the base station to the first reflector and a second straight-line distance from the first reflector to the second reflector is 2.5 m or longer and 250.0 m or shorter.

2. The radio transmission system according to claim 1, wherein a sum total of the first straight-line distance, the second straight-line distance, and the third straight-line distance from the second reflector to a farthest part of a boundary of a blind zone in a reflecting direction of the second reflector is 5.0 m or longer and 300.0 m or shorter.

3. The radio transmission system according to claim 1, wherein the second reflector is installed in an NLOS environment in which the base station cannot be directly seen.

4. The radio transmission system according to claim 1, wherein at least one of the first and second reflectors is formed by connecting a plurality of reflectors with one another.

5. The radio transmission system according to claim 1, wherein a plane size of the first or second reflector is 0.1 m×0.1 m or larger and 3.0 m×3.0 m or smaller.

6. The radio transmission system according to claim 4, wherein a plane size of each of the plurality of reflectors is selected in a range of 0.1 m×0.1 m or larger and 3.0 m×3.0 m or smaller.

7. The radio transmission system according to claim 1, wherein at least one of the first and second reflectors includes a meta-surface on at least a part of its reflection surface, the meta-surface being configured to reflect an incident electromagnetic wave at an angle different from an incident angle thereof.

8. The radio transmission system according to claim 1, wherein at least one of the first and second reflectors includes a specular reflection surface on at least a part of its reflection surface, the specular reflection surface being configured to specularly reflect an incident electromagnetic wave.

9. The radio transmission system according to claim 1, wherein at least one of the first and second reflectors includes a protective layer on an outermost layer, the protective layer being configured to block ultraviolet light.

10. The radio transmission system according to claim 1, wherein the transmitting antenna of the base station is installed at a height of 0.5 m or higher and 5.0 m or lower from a floor or a road surface.
